(19) United States
(12) Patent Application Publication
(10) Pub. No.: US 2024/0311562 A1
(43) Pub. Date: Sep. 19, 2024

(54) INFORMATION PROCESSING DEVICE AND METHOD FOR PROCESSING INFORMATION

(71) Applicant: FRONTEO, Inc., Tokyo (JP)

(72) Inventor: Keisuke TOMIYASU, Tokyo (JP)

(73) Assignee: FRONTEO, Inc., Tokyo (JP)

(21) Appl. No.: 18/605,073

(22) Filed: Mar. 14, 2024

(30) Foreign Application Priority Data
Mar. 15, 2023 (JP) 2023-040721

(51) Int. Cl. G06F 40/268; G06N 20/20

(52) U.S. Cl. CPC G06F 40/268; G06N 20/20

(57) ABSTRACT

An information processing device including: an obtaining unit configured to obtain document data; an analysis processing unit configured to perform morphological analysis of the document data; a feature determining unit configured to determine a feature in accordance with a result of the morphological analysis; and a learning processing unit configured to perform machine learning to determine a weight of a morpheme in a model in accordance with the feature, the morpheme being obtained by the morphological analysis, and the model being either a linear model or a generalized linear model, wherein the learning processing unit performs processing of deleting, from input data of the model, the feature corresponding to the morpheme having the weight a value of which is determined to be smaller than, or equal to, a given threshold value.

### CROSS-REFERENCE TO RELATED APPLICATION

The present application claims priority from Japanese Application JP2023-040721 the content of which is hereby incorporated by reference into this application.

### BACKGROUND OF THE INVENTION

### 1. Field of the Invention

The present invention relates to an information processing device, and a method for processing information.

### 2. Description of the Related Art

There are conventionally known techniques to process document data, using machine learning. For example, Japanese Unexamined Patent Application Publication No. 2022-148430 discloses a document information extracting system. When determining a feature of a model, the document information extracting system updates a parameter on the basis of an action type or a weight of the feature to be evaluated.

### SUMMARY OF THE INVENTION

In evaluating the feature, the technique disclosed in Japanese Unexamined Patent Application Publication No. 2022-148430 factors in, for example, similarity relationships in accordance with a similar dictionary, but fails to factor in increasing processing speed and diversity of morphemes to be input.

Some aspects of the present disclosure can provide an information processing device and a method for processing information that execute machine learning for various morphemes at high speed.

An aspect of the present disclosure relates to an information processing device including: an obtaining unit that obtains document data; an analysis processing unit that performs morphological analysis of the document data; a feature determining unit that determines a feature in accordance with a result of the morphological analysis; and a learning processing unit that performs machine learning to determine a weight of a morpheme in a model in accordance with the feature. The morpheme is obtained by the morphological analysis, and the model is either a linear model or a generalized linear model. The learning processing unit performs processing of deleting, from input data of the model, the feature corresponding to the morpheme having the weight a value of which is determined to be smaller than, or equal to, a given threshold value.

Another aspect of the present disclosure relates to a method, for processing information, causing an information processing device to perform: obtaining document data; performing morphological analysis on the document data; determining a feature in accordance with a result of the morphological analysis; and performing machine learning to determine a weight of a morpheme in a model in accordance with the feature. The morpheme is obtained by the morphological analysis, and the model is either a linear model or a generalized linear model. The machine learning involves performing processing of deleting, from input data of the model. The feature corresponds to the morpheme having the weight a value of which is determined to be smaller than, or equal to, a given threshold value.

### BRIEF DESCRIPTION OF THE DRAWINGS

FIG. 1 illustrates an exemplary configuration of a system including an information processing device;

FIG. 2 illustrates an exemplary configuration of the information processing device;

FIG. 3 illustrates another exemplary configuration of the information processing device;

FIG. 4 is a flowchart showing learning processing;

FIG. 5 is a flowchart showing inference processing;

FIG. 6 is a graph showing processing of correcting a score to probability data;

FIG. 7A is a table showing metadata features;

FIG. 7B is a table showing processing of correcting metadata features in accordance with a first norm;

FIG. 7C is a table showing processing of correcting metadata features in accordance with a second norm;

FIG. 8A is a diagram of highlight processing in accordance with a score for each block;

FIG. 8B shows an example of information representing weights of the respective morphemes;

FIG. 9 is a graph showing a forecast line, a forecast curve, and a confidence interval; and

FIG. 10 is a diagram showing processing of obtaining a plurality of evaluation data items.

### DETAILED DESCRIPTION OF THE INVENTION

Described below will be an embodiment, with reference to the drawings. Throughout the drawings, identical reference signs are used to denote identical or substantially identical constituent features. Such constituent features will not be elaborated upon repeatedly. Note that this embodiment described below will not unduly limit the description recited in the claims. Furthermore, not all of the configurations described in this embodiment are necessarily essential constituent features of the present disclosure.

### 1. Example of System Configuration

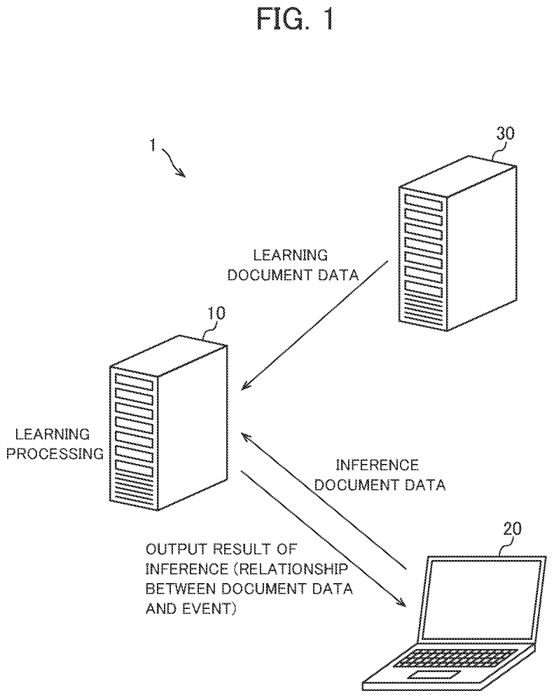

FIG. 1 is an exemplary configuration of an information processing system 1 including an information processing device 10 according to this embodiment. The information processing system 1 includes: the information processing device 10; a terminal device 20; and a second information processing device 30. Note that a configuration of the information processing system 1 shall not be limited to the configuration illustrated in FIG. 1. The configuration can be subjected to various modifications, such as either omitting a portion of the configuration or adding another configuration.

The information processing device 10, the terminal device 20, and the second information processing device 30 are connected to one another via, for example, a network. Here, the network is, for example, a public communications network such as the Internet. Note that the network may be such a network as a local area network (LAN), and a configuration of the network shall not be limited to any specific configuration.

The information processing device 10 is a device to perform machine learning according to this embodiment. For example, the information processing device 10 performs machine learning in accordance with learning document data, and generates a learned model to be used for processing of classifying the document data.

For example, the processing of classifying the document data may be processing of obtaining a degree of relationship between a predetermined event and a target document data item. Here, the predetermined event includes various events. For example, the information processing device 10 may be included in various systems such as a discovery support system to be described below, and the predetermined event may be any one or more of various events to be described below. Note that the predetermined event shall not be limited to the events to be listed below.
A case required for a discovery procedure on a discovery support system.
A crime that is subject to investigation on a criminal investigation support (forensics) system.
A fraudulent practice found on an e-mail monitoring system (e.g., information leakage and bid rigging).
An example and an event related to pharmaceuticals and found on a medical application system.
An example and an event related to the Internet and found on an Internet application system.
A project conducted in the past on a project evaluation system.
A commodity and a service targeted for marketing on a marketing support system.
An intellectual property to be evaluated on an intellectual property evaluation system.
A fraudulent financial transaction found on a fraudulent transaction surveillance system.
An example of a past response made on a call center escalation system.
A target of credit check on a credit check system.
An issue related to vehicle operation on a driving support system.
Sales results found on a sales support system.

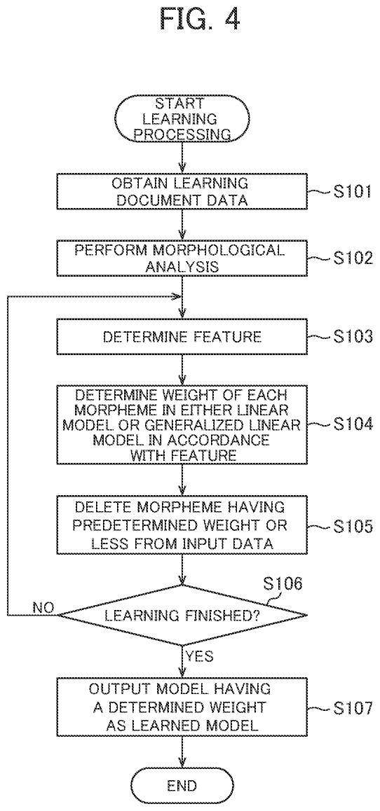

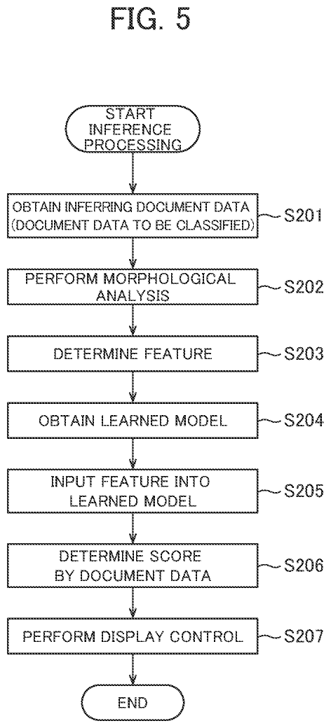

The information processing device 10 may be provided in the form of, for example, a server system. Here, the server system may be a single server, or may include a plurality of servers. For example, the server system may include a database server and an application server. The database server stores various data items including a learned model to be described later. The application server executes processing to be described later with reference to FIGS. 4 and 5. Note that, the plurality of servers here may be either physical servers or virtual servers. If the virtual servers are used, the virtual servers may be either provided to a single physical server or distributed among a plurality of physical servers. As can be seen, a specific configuration of the server system according to this embodiment can be modified in various manners. In other words, the information processing device 10 according to this embodiment may be provided in the form of either a single device, or a plurality of devices for distributed processing.

The terminal device 20 is a device that uses a result of learning by the information processing device 10. For example, the terminal device 20 transmits, to the information processing device 10, document data to be subjected to the classification processing, and obtains and displays a result of classifying the document data in accordance with the learned model generated by the information processing device 10.

The terminal device 20 is a personal computer (PC) to be used by a user using, for example, a classification service of document data. Note that the terminal device 20 may be such a device as a smartphone or a tablet terminal. A specific aspect of the terminal device 20 can be modified in various manners.

The second information processing device 30 is a device that collects learning document data to be used for machine learning, and transmits the collected learning document data to the information processing device 10. For example, the second information processing device 30 may be an e-mail server that collects learning e-mails on an e-mail monitoring system. In this case, the second information processing device 30 performs processing of transmitting and receiving e-mails to accumulate the e-mails, and transmits, as learning document data, some or all of the e-mails to the information processing device 10. Furthermore, the second information processing device 30 may collect learning document data on the basis of open information, or may obtain learning document data from the terminal device 20. In addition, various modifications can be made to a specific configuration of the second information processing device 30 and to a source to be used in collecting learning document data. Note that the second information processing device 30 is not essential, and may be omitted from the information processing system 1. For example, either the information processing device 10 or the terminal device 20 may collect learning document data.

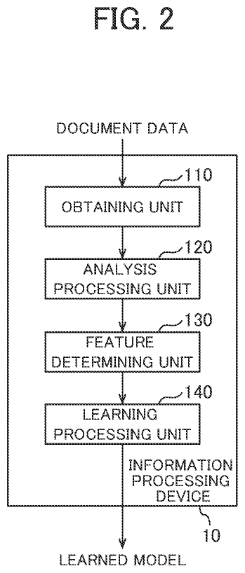

FIG. 2 is an exemplary configuration of the information processing device 10. The information processing device 10 includes: an obtaining unit 110; an analysis processing unit 120; a feature determining unit 130; and a learning processing unit 140. Note that a configuration of the information processing device 10 shall not be limited to the configuration illustrated in FIG. 2. The configuration can be subjected to various modifications, such as either adding a configuration, or adding another configuration.

The obtaining unit 110 obtains document data. For example, the obtaining unit 110 may obtain learning data in which the document data is provided with a result of classification serving as answer data. Processing of adding the answer data (annotation) is executed by, for example, the second information processing device 30. The obtaining unit 110 may be provided in the form of a communications interface that exchanges communications with the second information processing device 30. Here, the communications interface may be either an interface that handles communications compliant with the IEEE802.11 standard, or an interface that handles communications compliant with another standard. The communications interface may include, for example, an antenna, a radio frequency (RF) circuit, and a baseband circuit. Note that the annotation may be executed on either the information processing device 10, or the terminal device 20.

The analysis processing unit 120 obtains document data from the obtaining unit 110, and performs morphological analysis of the obtained document data. The morphological analysis is a method widely used in the field of natural language processing, and a detailed description of the analysis will not be elaborated upon here. The morphological analysis extracts, from one document data item, a plurality of morphemes included in the document data item.

The feature determining unit 130 determines a feature representing the document data item, in accordance with a result of the morphological analysis. Details of the feature will be described later.

The learning processing unit 140 performs machine learning to determine a weight of a morpheme in a model in accordance with the feature. The morpheme is obtained by the morphological analysis. The model in this embodiment is either a linear model or a generalized linear model. The linear model may be, for example, a model represented by an equation (1) below.

$$\begin{matrix}[ Math . 1 ] & \\ Document Score = f ( x ) = w 1 * x 1 + w 2 * x 2 + w 3 * x 3 + … + wn * xn & ( 1 )\end{matrix}$$

For example, the feature of a document data item in this embodiment may be a set of features of respective morphemes included in a plurality of morphemes. In the above equation (1), x1 to xn represent features corresponding to the respective morphemes, and w1 to wn represent weights of the respective morphemes. In the above equation (1), an objective variable of the model is a score of the document; that is, for example, a score indicating a degree to which, for example, a target document data item is relevant to a given event. Described below is an example in which a larger score indicates a higher degree of relevance between the document data item and the given event.

Furthermore, the generalized linear model is a model obtained when a linear model is generalized, and may be a model represented by, for example, an equation (2) below. Note that the generalized linear model shall not be limited to the model represented by the equation (2) below, and may be another model represented in accordance with a linear model f(x).

$$\begin{matrix}[ Math . 2 ] & \\ g ( x ) = \frac{1}{1 + f ( x )} & ( 2 )\end{matrix}$$

The technique of this embodiment uses either a linear model or a generalized linear model. Either model can reduce load on processing of learning, and over-training excessively adaptive to learning document data. Details of the processing on the learning processing unit 140 will be described later with reference to FIG. 4 and subsequent drawings.

The learning processing unit 140 outputs, as a learned model, either the linear model or the generalized linear model a weight of which is determined by the learning processing. Using the learned model, the document data can receive the classification processing. Note that the outputting of the learned model may be either processing of storing the learned model in a memory (e.g., a storage unit 200 to be described later) of the information processing device 10, or processing of transmitting the learned model to another device. For example, the information processing device 10 may transmit the learned model to the terminal device 20, and the terminal device 20 may execute the classification processing using the learned model.

Each of the units (in a narrow sense, the obtaining unit 110, the analysis processing unit 120, the feature determining unit 130, and the learning processing unit 140) of the information processing device 10 according to this embodiment includes hardware below. The hardware can include at least one of a digital signal processing circuit or an analogue signal processing circuit. For example, the hardware can include one or a plurality of circuit devices mounted on a circuit board, and one or a plurality of circuit elements. The one or the plurality of circuit devices are, for example, integrated circuits (ICs) or field-programmable gate arrays (FPGAs). The one or plurality of circuit elements are, for example, resistors or capacitors.

Furthermore, each of the units included in the information processing device 10 may be provided in a form of the processor below. The information processing device 10 of this embodiment includes: a memory that stores information; and a processor that operates on the information stored in the memory. The information includes, for example, a program and various kinds of data. The program may include a program to cause the information processing device 10 to execute the processing described in this Specification. The processor includes hardware. The processor can include various kinds of processors such as, for example, a central processing unit (CPU), a graphics processing unit (GPU), and a digital signal processor (DSP). The memory may be: a semiconductor memory such as a static random access memory (SRAM), a dynamic random access memory (DRAM), or a flash memory; a resistor; a magnetic storage device such as a hard disk drive (HDD); or an optical storage device such as an optical disc drive. For example, the memory holds a computer-readable instruction. When the processor executes the instruction, a function of the information processing device 10 is carried out in the form of processing. Here, the instruction may be a set of instructions included in the program, or an instruction for instructing a hardware circuit of the processor to operate.

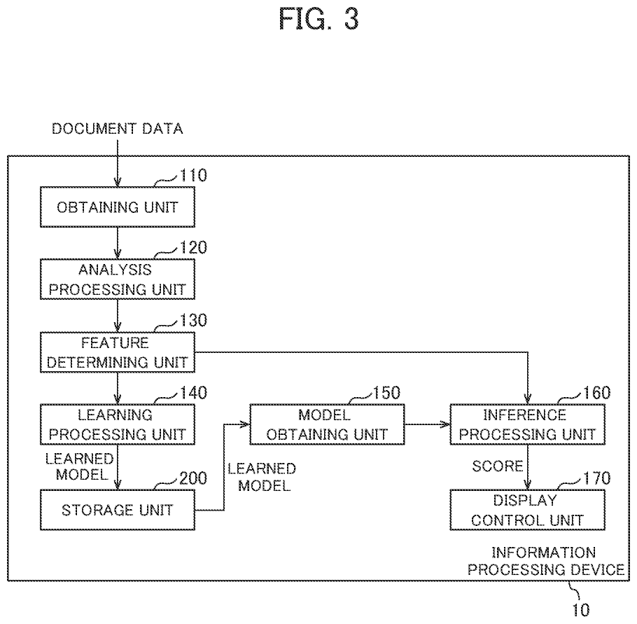

In addition to the learning process that generates the learned model, the information processing device 10 may execute inference processing (specifically, the classification processing described above) using the learned model. FIG. 3 illustrates another exemplary configuration of the information processing device 10. The information processing device 10 may include: the obtaining unit 110; the analysis processing unit 120; the feature determining unit 130; and the learning processing unit 140, and additionally include: a model obtaining unit 150; an inference processing unit 160; a display control unit 170; and the storage unit 200. The obtaining unit 110, the analysis processing unit 120, the feature determining unit 130, and the learning processing unit 140 are the same as thole exemplified in FIG. 2, and will not be elaborated upon here.

The model obtaining unit 150, the inference processing unit 160, and the display control unit 170 are provided in the forms of the above various processors including, for example, a CPU, a GPU, and a DSP. The storage unit 200 is a working area of the processor, and stores various kinds of information. The storage unit 200 may be provided in the form of various kinds of memories. The memories may include: a semiconductor memory such as an SRAM, a DRAM, a ROM, or a flash memory; a resistor; a magnetic storage device; and an optical storage device.

The model obtaining unit 150 obtains the learned model generated by the learning processing unit 140. For example, the learning processing unit 140 stores the generated learned model in the storage unit 200. The model obtaining unit 150 performs processing of reading out a desired learned model from the storage unit 200. For example, the e-mail monitoring system may separately generate: a learned model directed to a case where a given event to be monitored is related to power harassment; and a learned model directed to a case where a given event to be monitored is related to sexual harassment. Alternatively, the e-mail monitoring system may separately generate: a learned model for monitoring employees who belong to the sales department; and a learned model for monitoring employees who belong to the research and development department. In such cases, the model obtaining unit 150 may perform processing of selecting a learned model that matches the details of the monitoring to be carried out.

The inference processing unit 160 performs inference processing, using the learned model obtained by the model obtaining unit 150. Specifically, the inference processing unit 160 may input a document data item to be subjected to the classification processing into the learned model, in order to obtain a score of the document data item. As described above, the score represents a degree of relevance between the document data item and a given event.

Note that, when the document data item is input into the learned model, the document data item undergoes morphological analysis and feature determining processing. For example, the obtaining unit 110 may obtain not only a learning document data item but also a document data item to be classified. The analysis processing unit 120 performs morphological analysis of the document data item. The feature determining unit 130 determines a feature representing the document data item to be classified, in accordance with a result of the morphological analysis.

The inference processing unit 160 inputs the determined feature into the learned model. As a result, the obtaining unit 110, the analysis processing unit 120, and the feature determining unit 130 can be shared for the learning processing and the inference processing. Note that, a second obtaining unit, a second analysis processing unit, and a second feature determining unit (not shown) for classification processing may be provided separately from the obtaining unit 110, the analysis processing unit 120, and the feature determining unit 130. As to specific configurations of the separately provided units, various modifications can be made to the units.

The display control unit 170 performs control to display a result of processing performed by the inference processing unit 160. For example, the display control unit 170 causes a display unit of the terminal device 20 to display the result of processing performed by the inference processing unit 160. In this case, the terminal device 20 may run a web application using, for example, an Internet browser. For example, the information processing device 10 includes a web application server, and the browser of the terminal device 20 makes access to the web application server.

The terminal device 20 determines document data to be classified in accordance with an operation of the user, and requests the information processing device 10 to perform classification processing of the document data. The inference processing unit 160 of the information processing device 10 executes the classification processing as described above, and the display control unit 170 causes the display unit of the terminal device 20 to display the result of the classification processing. Here, the display control may be processing of transmitting markup language for causing the display unit of the terminal device 20 to display a screen including the result of classification. Note that the display control unit 170 may present the result of classification processing in a mode viewable for the user. A specific display control shall not be limited to the above control.

### 2. Processing Flow

### 2.1 Learning Processing

FIG. 4 is a flowchart showing a processing flow according to this embodiment; that is, a flowchart showing learning processing for machine learning in accordance with, in particular, learning document data.

First, at Step S101, the obtaining unit 110 obtains learning document data. For example, the obtaining unit 110 may obtain, as the learning document data, document data associated with answer data on the second information processing device 30. Furthermore, the obtaining unit 110 may obtain the learning document data from an appliance other than the second information processing device 30. Alternatively, the obtaining unit 110 may obtain document data not associated with answer data. Then, the obtaining unit 110 may associate the obtained document data with answer data, in order to obtain learning document data. The answer data is input by, for example, the user. The user may use either the information processing device 10, or another appliance such as the terminal device 20, to input the answer data.

Here, the answer data is information indicating whether the target document data is relevant to a given event. For example, considered is a case where the information processing device 10 performs, on an e-mail monitoring system, processing for detecting document data relevant to power harassment. In this example, the answer data is binary information indicating whether the target document data (i.e., an e-mail) is relevant to power harassment. For example, the user who assigns the answer data views details of the target document data, and enters, as the answer data, data representing a result of determination indicating whether the document data is relevant to power harassment. Note that the answer data shall not be limited to binary data, and may be, for example, numerical data configured in three or more levels and representing a degree of relevance to a given event.

At Step S102, the analysis processing unit 120 performs morphological analysis processing on learning document data. Here, a morpheme represents the smallest unit that makes sense language-wise in a sentence. The morphological analysis includes processing to break down the document data into a plurality of morphemes. The analysis processing unit 120 obtains, as a result of the morphological analysis, a set of morphemes included in the document data. Note that the analysis processing unit 120 may determine, for example, parts of speech of the morphemes, and the determination result may be included in the results of the morphological analysis. The morphological analysis is a technique widely used in the field of natural language processing, and a detailed description of the analysis will not be elaborated upon here.

At Step S103, the feature determining unit 130 determines a feature corresponding to the document data. For example, in accordance with an occurrence state of a given morpheme in the target document data, the feature determining unit 130 may perform processing of determining a value corresponding to the given morpheme. Then, the feature determining unit 130 may use a tensor (in a narrow sense, a vector) as a feature representing the target document data. In the tensor, values obtained for the respective morphemes are arranged.

For example, the feature determining unit 130 may use, as a value corresponding to a given morpheme, binary data indicating whether the morpheme is included in the document data. The binary data may be data representing: a first value (e.g., 1) when the morpheme is included in the document data; and a second value (e.g., 0) when the morpheme is not included in the document data. For example, if the target document data includes three morphemes of “Impossible is nothing”, the feature of the document data is a vector indicating that values of elements corresponding to “Impossible”, “is”, and “nothing” are 1, and values of the other elements are 0.

Alternatively, the feature determining unit 130 may use, as a value corresponding to a given morpheme, a value based on term frequency (tf) representing occurrence frequency of the morpheme. Furthermore, the feature determining unit 130 may use, as a value corresponding to a given morpheme, a value determined in accordance with tf and inverse document frequency (idf).

At Step S104, the learning processing unit 140 performs learning processing using a feature as input data of a model. Specifically, x1 to xn in the equations (1) and (2) correspond to the features (the elements of the vectors) determined at Step S103, and a score of the document data corresponds to the answer data. The learning processing unit 140 performs processing to determine the most probable weights w1 to wn, in accordance with a set of (scores x1, x2 . . . xn) obtained from many learning document data items. Various known linear optimization techniques, including the steepest descent, the Newton's method, and the primal-dual interior-point method, are employed for processing of determining a weight for the linear model. These techniques are widely applicable to this embodiment.

At Step 105, the learning processing unit 140 executes processing of excluding, from subsequent learning processing, a morpheme included in a plurality of morphemes and having a corresponding weight value smaller than, or equal to, a predetermined threshold value. For example, the learning processing unit 140 performs processing of deleting, from input data of the model, the feature corresponding to the morpheme a value of the weight determined to be smaller than, or equal to, a given threshold value. More specifically, if the weight wi (i is an integer of 1 or more and n or less) corresponding to a given morpheme is determined to be smaller than, or equal to, a predetermined threshold, the learning processing unit 140 may delete a term corresponding to wi×xi from the model represented by the above equations (1) and (2). As a result, the i-th morpheme corresponding to xi is excluded from the targets of the learning process.

The technique of this embodiment allows the learning processing unit 140 to automatically determine whether a given morpheme is used for processing. Hence, for example, in performing the learning processing first at Step 104, the technique can reduce necessity for performing processing of reducing load, such as partially filtering a morpheme in advance. In a narrow sense, the learning processing unit 140 may use all the morphemes, extracted from the learning document data, for the learning processing. Alternatively, the learning processing unit 140 may use features, corresponding to all the morphemes assumed in a target natural language, for the learning processing.

As can be seen, the technique of this embodiment eliminates the need for previously excluding some of the morphemes, thereby successfully reducing load accompanied by pre-processing of the learning processing. For example, when a morpheme is erroneously detected because of an error in morphological analysis, a conventional technique performs processing of excluding an inappropriate morpheme. In contrast, this embodiment can automatically exclude such an inappropriate morpheme. This is because the influence of the inappropriate morpheme is little on the degree of relevance between the document data and a given event. Thus, in the processing at Step S104, a small weight deemed to be spontaneously set. For example, as to languages such as Chinese, Japanese, and Korean languages, one morpheme could have a very low character count. Hence, it is more difficult to execute morphological analysis on those languages than on other languages (e.g., English language). The technique of this embodiment has an advantage in that, even if such languages as Chinese, Korean, and Japanese languages are the target languages, errors in morphological analysis can be automatically excluded in the learning process.

Furthermore, the document data according to this embodiment may be voice data, and the voice data may be obtained by voice recognition processing. In this case, the audio recognition processing might make an error, and an inappropriate morpheme might be obtained. However, this embodiment automatically removes such an inappropriate morpheme. This is because even if the cause of the error is the audio recognition processing, it is also deemed that the influence of the inappropriate morpheme is little on the degree of relevance between the document data and a given event. That is, the technique of this embodiment can automatically remove, using a model of the learning processing, an error that might occur in processing in a previous stage of the learning processing such as voice recognition processing and morphological analysis.

Note that, as to the technique of this embodiment, it is also important that the model is either a linear model or a generalized linear model. It is because, as described above with reference to FIG. 4, this embodiment first executes processing of determining weights first for many (in a narrow sense, all) morphemes (Step S104), and then, using a result of the processing, automatically excludes some of the morphemes (Step S105). Hence, processing for many morphemes is required at least once. When a model to be used has a relatively large processing load (e.g., a neural network having multiple intermediate layers), the morphemes in large numbers, that is, input data items in large numbers, inevitably increase load on processing for determining the weights at first. Such a problem could impair the advantageous effect of reducing the load by automatically excluding some of the morphemes. In this regard, as described above, using either a linear model or a generalized linear model that is mathematically easy to analyze, the technique of this embodiment can efficiently determine the weights even if many morphemes are processed, thereby successfully and appropriately reducing the load on the learning processing.

After deleting morphemes having a predetermined weight or less, at Step 106, the learning processing unit 140 determines whether to finish the learning processing. For example, the learning processing unit 140 may perform cross validation to obtain an index value representing accuracy of the learning, and determine whether to finish the learning in accordance with the index value. The cross validation is a technique of dividing a plurality of learning data items into N units (N is an integer of 2 or more), updating the weights using N−1 units among the N units as training data, and obtaining the index value using the remaining 1 unit as test data (validation data). The cross validation is a known technique, and a detailed description of the technique will not be elaborated upon here. Furthermore, the index value here can include various index values such as a recall, an accuracy rate, a precision, and an area under the curve (AUC).

If the learning processing unit 140 determines not to finish the learning (Step S106: NO), the learning processing unit 140 returns to, for example, Step S103, and performs processing. In this case, the features corresponding to the morphemes are recalculated, and, in accordance with the recalculated features, the weights of the morphemes are determined. Here, a morpheme deleted at Step 105 may be excluded from the morphemes subjected to feature calculation. Furthermore, at Step 104, a control parameter to be used for the learning may be partially changed.

Alternatively, if the learning processing unit 140 determines not to finish the learning (Step S106: NO), the learning processing unit 140 may return to, for example, Step S104, and perform processing. In this case, the learning processing unit 140 uses a determined value for the feature, partially changes the control parameter different from the feature, and then again executes the processing of determining the weight.

If the learning processing unit 140 determines to finish the learning (Step S106: NO), the learning processing unit 140 outputs, as a learned model, either the linear model or the generalized linear model a weight of which is determined at that time. Then, the learning processing unit 140 finishes the learning processing.

### 2.2 Inference Processing (Classification Processing of Document Data)

FIG. 5 is a flowchart showing processing according to this embodiment; that is, a flowchart showing processing of classifying document data to be classified in accordance with, in particular, a learned model. Here, the classification processing includes processing for each of the document data items to obtain a score indicating a degree of relevance between each document data item and a given event.

First, at Step S201, the obtaining unit 110 obtains document data to be classified. For example, a user of the terminal device 20 selects one or a plurality of e-mails to be monitored for power harassment, and the obtaining unit 110 performs processing of obtaining the selected e-mails as document data to be classified.

At Step S202, the analysis processing unit 120 performs morphological analysis of the document data. At Step 203, the feature determining unit 130 determines a feature corresponding to the document data, in accordance with a result of the morphological analysis. The processing at Steps S202 and S203 is the same as the processing at Steps S102 and S103 in FIG. 4. Note that the feature determining unit 130 may exclude a morpheme, deleted from the input data of the learned model, as a target of the feature determining processing.

At Step S204, the model obtaining unit 150 obtains a learned model. When the information processing device 10 performs classification processing as described above with reference to FIG. 3, the model obtaining unit 150 performs processing of reading out, from the storage unit 200, a learned model corresponding to the details of the classification processing.

Next, the inference processing unit 160 performs inference processing, using the learned model. Specifically, at Step S205, the inference processing unit 160 inputs the feature obtained at Step 203 into the learned model. Then, at Step S206, the inference processing unit 160 calculates a score corresponding to target document data. Specifically, the inference processing unit 160 inputs features into x1 to xn of the above equation (1) or (2) (except for the features deleted at Step 105 in FIG. 4), and multiplies the weights acquired in the learning processing to obtain the score of the document data item. Here, the score is information indicating a degree of relevance between the target document data and a given event.

At Step S207, the display control unit 170 causes the terminal device 20 to display a result of calculating the score. For example, the display control unit 170 may perform processing to cause the display unit of the terminal device 20 to display a list of document data items included in a plurality of document data items to be classified and determined to have a predetermined score or more.

### 3. Specific Example of Processing on Information Processing Device

Described below will be an example of more detailed processing in either the learning processing or the inference processing.

### 3.1 Probability Data Output

As described above, the score in this embodiment may be a value determined in accordance with an output value of a model. Here, the score is, for example, information indicating a degree of relevance between document data and a given event, as described above. The score may also be numerical data indicating likelihood that the document data item and the given event are relevant to each other. For example, the score is information indicating that the greater the value of the score is, the higher the degree of relevance is between the document data and the given event.

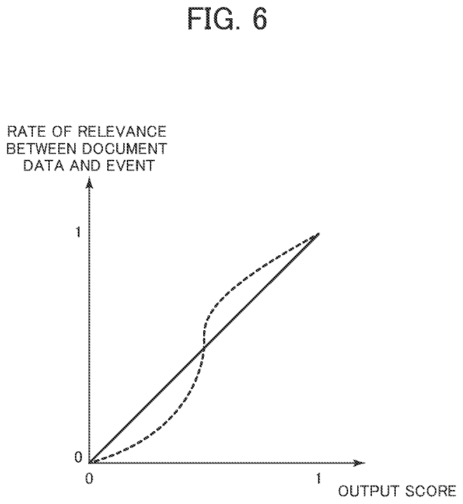

FIG. 6 shows information indicating an output value of a model and a rate of relevance between document data items and a given event. The horizontal axis of FIG. 6 indicates an output value of the model. The vertical axis of FIG. 6 indicates a ratio of the number of document data items actually relevant to a given event to the total number of document data items for which, for example, an output value of the model is a given value. The value of the vertical axis of FIG. 6 may be determined in accordance with, for example, test data for the cross validation. For example, a plurality of document data items included in the test data are input into a learned model, and, as a result, Ns document data items each having a score S are to be obtained. With reference to the answer data of the Ns document data items, x document data items out of the Ns document data items are found to be relevant to a given event, and the rest of the document data items (i.e., (Ns−x) document data items) are found not to be relevant to the given event. In this case, the value Ps of the vertical axis when the value of the horizontal axis is S is expressed as Ps=(x/Ns). Hereinafter, the value of the vertical axis is referred to as a “rate of document data items relevant to a given event”, and is also simply referred to as a “rate”.

In this case, the score and the rate might not be in a linear relationship. For example, as shown by the broken line of FIG. 6, the rate might be a non-linear function in relation to the score. Note that, in FIG. 6, the score is normalized to a value of 0 or more and 1 or less; however, the score may be represented in any given manner.

For example, if the score is 20% of a maximum value (e.g., 0.2), the user viewing the score might determine that the document data item is relevant to the given event with a probability of 20%. However, when the score is 0.2 in the example of FIG. 6, the value of the rate of the vertical axis is smaller than 0.2. That is, the probability is lower than 20% as to the relevance of the document data item having a score of 0.2 to the given event. Likewise, when the score is 0.8 in the example of FIG. 6, the value of the rate of the vertical axis is larger than 0.8. That is, the probability is higher than 80% as to the relevance of the document data item having a score of 0.8 to the given event. Hence, when the score and the rate are in a non-linear relationship, deviation is observed between the impression that the user feels from the value of the score and the actual rate.

Furthermore, the relationship between the score and the rate might vary depending on learning document data. For example, different learning document data is used when the information processing device 10 of this embodiment is used either for the discovery support system or for the e-mail monitoring system. This means that the relationship between the scores and the rates varies between the two systems, and the meaning of the scores is different for each system. Furthermore, even in the e-mail monitoring system, the relationship between the scores and the rates could be different in a case where the given event is directed to either power harassment or sexual harassment.

Hence, this embodiment may perform processing of correcting a score to reduce deviation between the score and the rate. Specifically, the information processing device 10 performs correction processing so that the rate approximates to a liner function of the score. Here, the correction processing may be, for example, correction processing of approximating a value of the score to a value of the actual rate. For example, if S is a value of a pre-corrected score, which is an output of a model, and Ps is a value of a rate corresponding to the pre-corrected score, the value of the pre-corrected score is corrected to approximate from S to Ps. This correction can match the value of the corrected score with the value of the rate corresponding to the corrected score. In the example of FIG. 6, the relationship between the score and the rate is corrected so that the broken line is transformed into the solid line.

For example, the information processing device 10 obtains relationship data indicating a correspondence relationship between a score and a rate, using the test data for the cross validation as described above. Here, the relationship data may be a function F in which a relationship of a rate=F (score) holds, or may be data in the form of a table in which a value of a score and a value of a rate are associated with each other. If the relationship data is known, the value Ps of a rate can be determined when the value of the pre-corrected score is S. Hence, the correction described above can be appropriately executed.

As a result of the correction processing, for example, if the corrected score is 20% of the maximum value, it is expected that the target document data is relevant to the given event with a probability of approximately 20%. That is, the inference processing unit 160 may output, as a score (the corrected score described above), probability data indicating probability that inference target data is related to the given event. Such a score can associate the impression, which the user has when he or she views the score, with the rate. Furthermore, the technique of this embodiment can use the corrected score as probability data, regardless of a kind of the given event. That is, the meaning of the score is constant regardless of a system to which the information processing device 10 is applied or of a difference between events to be handled in the system. As a result, the user can easily make a decision. Furthermore, when filtering is performed with a score in display control of the display control unit 170, the user can uniform criterion for the decision making in the filtering, regardless of a system or a given event.

Note that, exemplified above is a case where an output of the model is obtained as the pre-corrected score, and, after that, the correction processing is performed on the pre-corrected score in accordance with the relationship data. The correction processing is carried out when, for example, the learning processing unit 140 obtains the relationship data between the pre-corrected score and the rate at the learning stage, and the inference processing unit 160 executes the correction processing at the inference stage in accordance with the relationship data. Note that, the correction processing of this embodiment shall not be limited to such an example. For example, the information processing device 10 may perform processing of correcting the weights w1 to wn so that the output of the model is the corrected score. That is, the learning processing on the learning processing unit 140 may involve executing the correction processing.

### 3.2 Automatic Parameter Setting

As described above with reference to FIG. 4, the learning processing unit 140 determines whether to finish the learning processing in accordance with an index value (Step S106). If the learning processing unit 140 determines not to finish the learning processing, the learning processing unit 140 continues the learning processing. When continuing the learning process, the learning processing unit 140 may make any given setting change related to the learning processing, and again perform processing of determining a weight of a morpheme.

The learning processing unit 140 may be capable of performing ensemble learning of obtaining, as the model, a plurality of models to be used in combination in the inference processing. Specifically, the learning processing unit 140 may be switchable between whether or not to execute the ensemble learning (switchable between ON and OFF of the ensemble learning).

For example, as to the ensemble learning, a technique referred to as bagging is known. The bagging is to obtain a plurality of training data items with diversity, using bootstrapping, to obtain a plurality of models from the plurality of training data items, and to perform estimation using the plurality of models. Other than the bagging, the ensemble learning includes various known techniques such as boosting, stacking, and neural networking. These techniques are widely applicable to this embodiment.

For example, the learning processing unit 140 may perform processing of evaluating the model obtained in the learning processing (Step S106). If performance of the model is determined to be lower than, or equal to, a predetermined level (Step S106: NO), the learning processing unit 140 may cancel ensemble in the ensemble learning (turn OFF the ensemble learning), and continue the machine learning. In other words, the learning processing unit 140 of this embodiment may automatically change a control parameter for determining ON and OFF of the ensemble learning.

The ensemble learning is deemed higher in accuracy than learning processing using a single model. However, if a sufficient amount of learning data is unavailable, the ensemble learning could even decrease estimation accuracy. For example, as to the systems assumed to be used in this embodiment, such as the discovery support system and the e-mail monitoring system, a rate of document data items relevant to a given event is assumed significantly low among collected document data items. Hence, even if a large number of document data items are collected in total, an amount of data classified into one category (the number of document data items relevant to a given event) might be insufficient. In this case, too, the ensemble learning could decrease accuracy. In this regard, this embodiment can automatically switch ON and OFF of the ensemble learning, while evaluating a created model. As a result, this embodiment allows execution of appropriate learning processing in accordance with a collection state of the learning document data items.

Alternatively, the learning processing unit 140 performs processing of evaluating a model. If performance of the model is determined to be lower than, or equal to, a predetermined level in the processing of evaluating, the learning processing unit 140 may continue the machine learning while the feature determining unit 130 changes a feature model to be used for determining the feature. Here, the feature model is a model for determining a value corresponding to each of the morphemes in the document data, in accordance with an occurrence state of each morpheme. As described above, the feature model may be a model that assigns binary data to each morpheme, a model that assigns a value corresponding to tf to each morpheme, or a model that assigns a value corresponding to tf-idf to each morpheme. Alternatively, the feature model may be a model other than these models.

For example, if target document data is a long sentence having a predetermined word count or more, or is expressed in a literary language even if the target document data is a short sentence, the accuracy is likely to be higher when tf is used than when binary data is used. Whereas, as to document data expressed in a short sentence and a literary language, it has been found out that the accuracy is likely to be higher when a simple feature model with binary data is used than when tf is used. The technique of this embodiment automatically changes the feature model, thereby successfully executing appropriate learning processing in accordance with, for example, a length of document data and an expression used in the document data.

Alternatively, the learning processing unit 140 performs processing of evaluating the model. If performance of the model is determined to be lower than, or equal to, a predetermined level in the processing of evaluating, the learning processing unit 140 may change the model (a function model) used for the machine learning, and continue the machine learning. For example, if performance of a learned model, obtained using the linear model represented by the above equation (1), is determined to be lower than, or equal to, a predetermined level, the learning processing unit 140 may change the learned model to the generalized linear model represented by the equation (2), and perform the machine learning. Furthermore, the learning processing unit 140 may change the generalized linear model to the linear model. Moreover, as described above, an aspect of the generalized linear model shall not be limited to the above equation (2). For example, the storage unit 200 may store a plurality of different generalized linear models. If performance of the model is determined to be lower than, or equal to, a predetermined level in the processing of evaluating, the learning processing unit 140 may perform processing of changing the function model on any one of unselected models among the linear model and the plurality of generalized linear models. In addition, various modifications can be made to the technique of changing the model (the function model).

### 3.3 Metadata

Furthermore, in this embodiment, metadata may be assigned to document data. Here, the metadata includes, for example, a character count and a line count in the document data, and the distribution and statistic of these counts (e.g., an average value, a center value, standard deviation). Moreover, the document data of this embodiment may be data including a transcript of a conversation among a plurality of people. For example, the obtaining unit 110 may obtain voice data that is a recorded conversation, and perform voice recognition processing on the voice data, in order to obtain the document data. In this case, the metadata of the document data includes, for example, a character count in a speech, a line count in the speech, and a time period of the speech, for each person. For example, if the document data is for a conversation between a customer and an employee, the metadata includes, for example, a character count in the customer's speech, a character count in the employee's speech, and time distribution. Furthermore, the metadata may include, for example, a rate of a character count in the customer's speech, and a rate a character count in the employee's speech, with respect to a character count in the whole conversation. For example, the metadata may include the name of a file path where the document data is stored, and the time and date when an e-mail is exchanged.

The metadata may be used for learning processing. For example, the feature determining unit 130 may determine a metadata feature in accordance with metadata assigned to document data. The metadata feature is a feature corresponding to the metadata. The learning processing unit 140 performs machine learning in accordance with a feature corresponding to a morpheme and the metadata feature. Hence, the metadata different from the morpheme can be included in the feature, thereby successfully improving learning accuracy.

Note that, in the learning process, the learning processing unit 140 may obtain a weight corresponding to metadata, and delete, from input data of a model, metadata whose weight has a value equal to, or smaller than, a predetermined threshold value. In this way, not only morphemes but also metadata can be automatically selected using a model, thereby eliminating the need of a person previously selecting the morphemes and the metadata in accordance with, for example, experience of the person.

Note that, a value of the metadata could vary widely for each data item. For example, a character count in a speech is likely to be great compared with a line count in a speech. Furthermore, a time period of a speech could vary depending on whether the time period is counted by either seconds or minutes. Hence, if a value of the metadata is used as it is as a feature, a feature having a large value greatly affects the learning model, and the whole feature could not be learned thoroughly. Moreover, if a decision tree or a random forest is used, the learning can be conducted regardless of the difference in units or scales. However, these techniques exhibit strong nonlinearity, and are not used in this embodiment as described above.

For example, considered is a case where first to P-th pre-corrected features are obtained as pre-corrected features corresponding to metadata, and where first to Q-th documents are obtained as document data. P represents the number of kinds of the features corresponding to the metadata, and Q represents the number of document data items. Here, each of P and Q is an integer of 1 or more. Note that, in reality, it is assumed that there are multiple kinds of metadata and multiple document data items. Hence, each of P and Q may be an integer of 2 or more.

The feature determining unit 130 may correct the first to the P-th pre-corrected features in accordance with the P of the pre-corrected features, the Q of the document data items, a first norm obtained with an i-th pre-corrected feature (i is an integer of 1 or more and P or less) that appears in the first to the Q-th documents, and a second norm obtained with the first to P-th pre-corrected features that appear in a j-th (j is an integer of 1 or more and Q or less) document, in order to determine the metadata feature. In this way, the metadata feature can be appropriately normalized. Specifically, the correction based on the first norm can reduce a difference in value between metadata items, thereby successfully conducting appropriate learning even in a case where either a linear model or a generalized linear model is used. Furthermore, the correction based on the second norm is also performed, thereby successfully unifying information (e.g., sum of squares) corresponding to the sum of the features for each of the documents. As a result, a format of the feature to be obtained is the same as a format of the feature directed only to language information (morphemes). Hence, also in the case where the metadata is used, the learning can be conducted by the same processing as the processing for the language information.

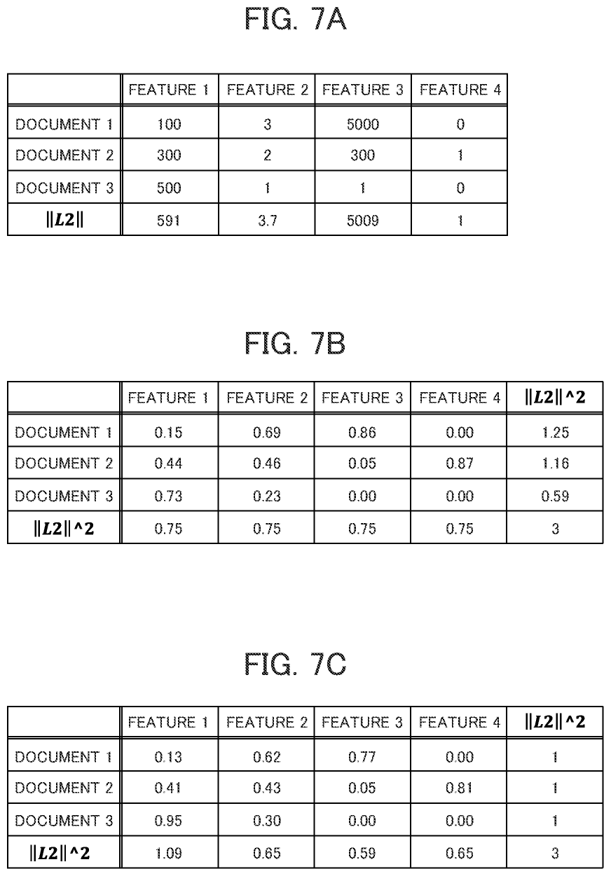

FIGS. 7A to 7C are tables specifically showing processing of correcting (normalizing) metadata features. FIG. 7A is a table showing pre-corrected metadata features. Here, exemplified is a case of documents 1 to 3 with four metadata features and three document data items. That is, exemplified is a case where P is 4 and Q is 3.

As shown in FIG. 7A, the values of the metadata feature 1 are 100, 300, and 500 for the respective documents 1, 2, and 3. The values of the metadata feature 2 are 3, 2, and 1 for the respective documents 1, 2, and 3. The values of the metadata feature 3 are 5000, 300, and 1 for the respective documents 1, 2, and 3. The values of the metadata feature 4 are 0, 1, and 0 for the respective documents 1, 2, and 3. In this example, the influence of the metadata features 1 and 3 are relatively strong. In FIG. 7A, ∥L2∥ represents an L2 norm; that is, a square root of the sum of squares. An L2 norm in the vertical direction is a norm obtained with the i-th pre-corrected feature (i is an integer of 1 or more and P or less) that appear in the first to the Q-th documents. Hence the L2 norm corresponds to the first norm.

FIG. 7B is a table showing correction processing using P, Q, and the first norm. FIG. 7B is a table showing a result of the correction processing represented by an equation (3) below for each of the elements in FIG. 7A. For example, the result of the correction processing performed on the metadata feature 1 is obtained by multiplication of ( 1/591)×√(¾). The correction processing shown in FIG. 7B uniforms the values with the square of L2 norms in the vertical direction to read 0.75 for all the metadata features. This correction processing can reduce the influence of the scale for each metadata feature.

$$\begin{matrix}[ Math . 3 ] & \\ Feature Corrected with First Norm = Pre - Corrected Feature \times \frac{1}{First Norm} \times \frac{\sqrt{Number of Documents}}{\sqrt{Number of Features}} & ( 3 )\end{matrix}$$

Furthermore, an L2 norm in the horizontal direction in FIG. 7B is a norm obtained with the first to the P-th pre-corrected features that appear in the j-th (j is an integer of 1 or more and Q or less) document. Hence, the L2 norm corresponds to the second norm. FIG. 7B clearly shows variation in metadata features; that is, the document 1 has large values of the metadata features as a whole, while the document 3 has small values of the metadata features as a whole. In this embodiment, the variation may be reduced by the correction processing using the second norm.

FIG. 7C is a table showing correction processing using the second norm. FIG. 7C is a table showing a result of the correction processing of multiplying each of the elements in FIG. 7B by 1/(the second norm). For example, the result of the correction processing performed on the document 1 is obtained when each of the elements is multiplied by (1/√1.25). The correction processing shown in FIG. 7C uniforms the values with the square of L2 norms in the horizontal direction to read 1 for all the metadata documents. This correction processing can make the format of the feature the same as a format of the feature directed only to language information. Note that the correction processing performed on the metadata features is represented as an equation (4) below.

$$\begin{matrix}[ Math . 4 ] & \\ Corrected Feature = Pre - Corrected Feature \times \frac{1}{First Norm} \times \frac{\sqrt{Number of Documents}}{\sqrt{Number of Features}} \times \frac{1}{Second Norm} & ( 4 )\end{matrix}$$

### 3.4 Highlighting by the Block

The inference processing unit 160 of this embodiment may perform processing of:

dividing inference target data into a plurality of blocks in any given length; and outputting probability data for each of the plurality of blocks. The probability data is provided as a score, and indicates a probability relevant to a given event. Note that the probability data here is obtained by the technique described above with reference to FIG. 6. Furthermore, the score may be the probability data itself of 0 to 1 inclusive (from 0% to 100% inclusive), or may be a value obtained by multiplication of the probability data by a given constant. For example, the score may be numerical data of 0 to 10000 inclusive.

The technique of this embodiment can calculate not only probability data of document data as a whole but also probability data of a block representing a portion of the document data. Hence, the technique can appropriately identify a portion deemed to be particularly important in the document data. Note that the block may be, but shall not be limited to, a paragraph, for example. Alternatively, the block may be set to include a plurality of paragraphs. Furthermore, one paragraph may be separated into a plurality of blocks. Moreover, the blocks may overlap with one another. In other words, the document data may have a given portion included in a first block and in a second block different from the first block. Furthermore, the blocks may be set either automatically or manually by user input.

For example, the feature determining unit 130 may obtain for each of the blocks a feature representing the block, and the inference processing unit 160 may input the feature into a learned model to obtain the probability data. Alternatively, the inference processing unit 160 may identify a morpheme included in a target block, and obtain a score of the block using a weight (any one of w1 to wn) corresponding to the morpheme.

The techniques using a decision tree and a random forest involve assessment using a feature, when determining a branch destination of each binary tree. Hence, when input document data is short and the number of the kinds of morphemes included in the document data is fewer than, or equal to, a predetermined number, a feature serving as a criteria of the assessment cannot be obtained. As a result, many binary trees cannot properly make determination to branch off. Consequently, in the techniques using, for example, a decision tree, processing accuracy could be significantly low when a short block is processed. In this regard, the technique of this embodiment uses either a linear model or a generalized linear model. Hence, a weight of each of the morphemes is calculated in the learning processing. Hence, even if the document data to be classified is short, the processing for obtaining a score using the weight can be appropriately executed, so that the estimation can be made with high accuracy even by the block.

For example, the inference processing unit 160 may compare, for each of the plurality of blocks, a score and a threshold value independent of a genre of the inference target data, and determine a display mode of each block in accordance with a result of the comparison. As described above, the score is corrected in a form of probability data, so that a difference between genres (specifically, kinds of given events whose degrees of relevance are to be determined) can be absorbed, and the meanings of the scores can be uniformed. Hence, the criteria assessment can be uniformed regardless of what the given event is. For example, if a range of the score is set from 0 to 10000 inclusive, the inference processing unit 160 may determine that the scores 1000 to 2499 inclusive are displayed in a first color, the scores 2500 to 3999 inclusive are displayed in a second color, and the scores 4000 to 10000 inclusive are displayed in a third color. The display control unit 170 executes control for displaying each block, using a display mode determined on the inference processing unit 160. For example, the display control unit 170 may perform display control to color a character or a background of each of the blocks in either basic colors (a black character and a white background) or any one of the first to the third colors, depending on the score. Note that the first to third colors may be any specific colors as long as the colors can be distinguished from each other.

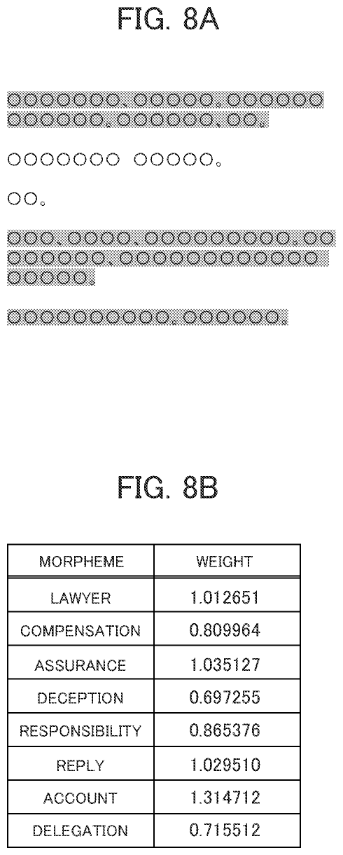

FIG. 8A is a diagram illustrating an example of a result of display control performed by the display control unit 170. In the example in FIG. 8A, the document data is divided into five blocks, and a first, a fourth, and a fifth blocks among the five blocks mark high scores. Hence, the display control unit 170 executes display control of changing a color of the backgrounds. Note that an example of the display control shall not be limited to this example. The example can be modified in various manners including, for example, changing the size of a character, adding a comment, and adding a frame line to surround a block.

Furthermore, as shown in FIG. 8B, the display control unit 170 may perform control of displaying weights (w1 to wn) obtained for the morphemes when displaying a result of determination made for each of the blocks of the document data. The example in FIG. 8B shows that values of the weights are assigned to the respective morphemes including “LAWYER” and “COMPENSATION”. When the screen in FIG. 8B is displayed together with the screen in FIG. 8A, the user can easily understand which morpheme is a factor to determine the display mode. Note that the screen in FIG. 8A and the screen in FIG. 8B may be either arranged and displayed in one window, or displayed in different windows.

Furthermore, if a plurality of inference target data items are obtained as the document data to be inferred, the inference processing unit 160 may perform processing of: calculating, by the document data item, a score for each of the plurality of inference target data items; and outputting, by the block, the score for each of the plurality of blocks for inference target data items included in the plurality of inference target data items and having relatively high scores.

As described above, a plurality of blocks are assumed to be set for one document data item. Hence, if a score is calculated by the block for all the document data items, the processing load increases. However, if the document data items subjected to score calculation by the block are narrowed down in accordance with a score by the document, the processing load can be reduced. For example, the inference processing unit 160 may perform processing, of obtaining a score by the block, on a document data item whose score by the document data item is a predetermined threshold value or more. Alternatively, the inference processing unit 160 may perform processing, of obtaining a score by the block, on a predetermined number of document data items in descending order of score by the document data item. Alternatively, the inference processing unit 160 may perform processing, of obtaining a score by the block, on a document data item either having a score zone comparable to a score zone of a document that the user would like to know, or including a similar word.

### 3.5 Cross-Validation and Forecast Curve

As described above, the display control unit 170 calculates a score for each of the plurality of document data items subjected to classification processing, and performs display control based on the score. Specifically, the display control unit 170 may cause the display unit of the terminal device 20 to display a list of document data items sorted in descending order of score. The user of the terminal device 20, for example, selects any one or more of the document data items displayed in the list to check the details of the selected document data item, and determines whether the document data item is actually relevant to a given event. Hereinafter, the process of determining whether the document data is relevant to a given event is also referred to as a review.

Even if the user of the terminal device 20 reviews a plurality of document data items in descending order of score, there might be a case where no document data item relevant to a given event is found. In such a case, the user could be in doubt whether the document data item relevant to the given event is not actually included in the plurality of document data items, or whether the problem lies in the accuracy of the system.

Hence, the learning processing unit 140 of this embodiment may perform processing of obtaining a forecast curve in accordance with a result of cross validation. Here, the forecast curve is information indicating, when the review proceeds, transition in the number of discovered document data items determined to be relevant to a given event. The forecast curve can show the user a prospective review result. For example, the forecast curve can allow the user to determine whether it is reasonable if a document data item relevant to a given event is not found by the review.

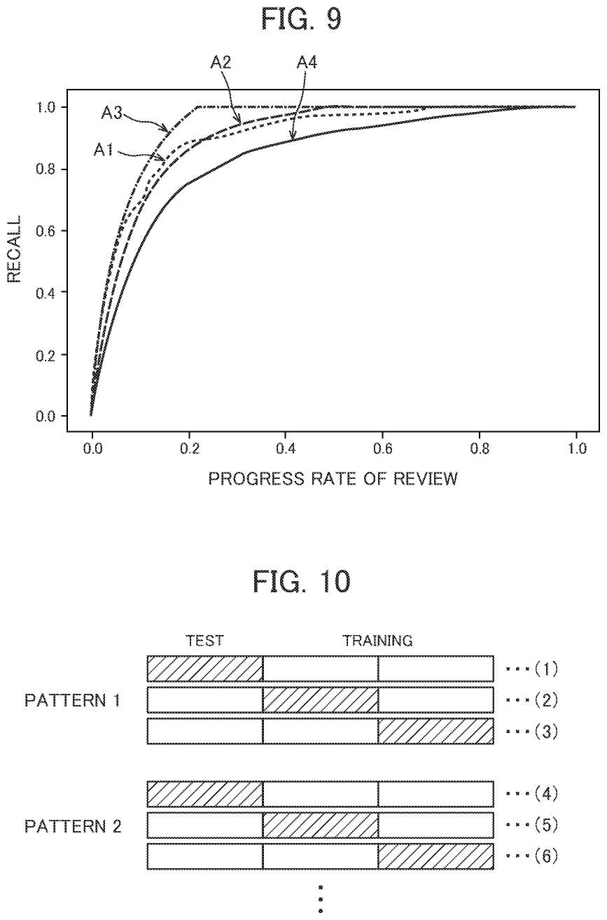

FIG. 9 illustrates exemplary forecast curves. The horizontal axis in FIG. 9 represents a progress rate of the review. That is, the horizontal axis represents a rate of reviewed document data items among document data items subjected to processing. The vertical axis represents a recall (a forecast recall). That is, the vertical axis in FIG. 9 represents a rate of document data items found (forecasted to be found) by the review among document data items relevant to a given event.

For example, considered is a case where: there are 1200 learning document data items; out of the learning document data items, 800 learning document data items are set as training data items to be used for machine learning; and the remaining 400 learning document data items are set as test data items to be used for validation of a learned model. Furthermore, considered here is an example where, out of the 400 test data items, 20 test data items are relevant to the given event, and the remaining 380 test data items are not relevant to the given event.

In this case, each of the 400 test data items is input into the learned model generated in accordance with the 800 training data items. Hence, a score of each test data item is calculated. Then, the 400 test data items are reviewed in descending order of score. Here, a correct answer data item is assigned to each test data item. Hence, the review is processing of determining whether each test data item is relevant to the given event in accordance with the correct answer data item. For example, when one document data item is reviewed, the value of the horizontal axis increases by 1/400. If the one document data item is relevant to the given event, the value of the vertical axis increases by 1/20. If the one document data is not relevant to the given event, the value of the vertical axis is maintained. This review is repeated until all the 400 document data items are completely reviewed, and a graph (a forecast line) is drawn in the coordinate system of FIG. 9. For example, A1 in FIG. 9 corresponds to the forecast line.

For example, assumed is a case where a set of coordinates (0.2, 0.9) are found on the forecast line. A value of 0.2 on the horizontal axis indicates that the document data items having the top 20% of the scores out of the 400 test data items; that is, the top 80 document data items, have been reviewed. A value of approximately 0.9 on the vertical axis indicates that, when the top 80 document data items are reviewed, only 20×0.9=18 document data items relevant to the given event have been found.

Note that, as A1 of FIG. 9 shows, the forecast line is not necessarily a smooth curve. For example, if there are not many documents relevant to the given event (e.g., 20 documents out of 400 documents in the above example), the forecast line is inevitably transformed into a stepwise line. This transformation into a stepwise line is probably due to a combination of the target training data items and test data items. Hence, the transformation could not be observed at a stage of the classification processing directed to different document data items. Hence, it is not preferable to show the user a forecast line including the stepwise transformation as the forecast curve.

Hence, in this embodiment, a plurality of combinations of training data items and test data items may be prepared, and a plurality of forecast lines obtained from the combinations may be averaged to obtain a forecast curve. Note that, in the cross validation, learning data is divided into N data items. Out of the N data items, N−1 data items are used as training data items, and the remaining 1 data item is used as a test data item. Hence, even normal N-fold cross validation can obtain N patterns of forecast lines. Note that, this embodiment may further increase the combination patterns of the data items to perform processing to obtain a more appropriate forecast curve.

For example, if a plurality of learning document data items are obtained as the document data, the learning processing unit 140 may sort the plurality of learning document data items to generate first to M-th (M is an integer of 2 or more) learning data items different from one another. Hence, the learning processing unit 140 performs the N-fold cross validation on each of the first to the M-th learning data items to obtain M×N patterns of evaluation data items.

FIG. 10 illustrates exemplary data patterns in processing of this embodiment. Here, three blocks arranged horizontally represent a result of the division by the N-fold cross validation. That is, FIG. 10 shows an example of performing three-fold cross validation. In FIG. 10, a shaded block is set as a test data item, and the remaining two blocks are set as training data items. Each block includes a plurality of document data items. For example, as described above, when the learning data includes 1200 document data items, each block includes 400 document data items.

In this case, when the 1200 document data items are sorted in an order defined by a pattern 1, the 1200 document data items are divided into three blocks of a 1st-to-400-th block, a 401-st-to-800-th block, and an 801-st-to-1200-th block. Hence, three learning data items are obtained. This corresponds to (1) to (3) of the pattern 1 in FIG. 10.

Furthermore, 1200 document data items are sorted in an order defined by a pattern 2 different from the pattern 1. The 1200 document data items are divided into three blocks of a 1st-to-400-th block, a 401-st-to-800-th block, and an 801-st-to-1200-th block. Hence, three learning data items are obtained. This corresponds to (4) to (6) of the pattern 2 in FIG. 10. Here, even in the same 1st-to-400-th block, the document data items are sorted in different orders between the pattern 1 and the pattern 2. Hence, the test data items of (1) and the test data items of (4) include different document data items. Likewise, the training data items of (1) and the training data items of (4) include different document data items. That is, even if the original learning data items are the same, the document data items are sorted in multiple order patterns and each cross-validated.

Thanks to such a technique, various data items can be used for machine learning.

As described above, the document data items are sorted in M order patterns from the pattern 1 to the pattern M, and each of the document data items is N-fold cross-validated. Hence, machine learning can be performed in M×N patterns. Thus, for a result of each machine learning pattern, M×N patterns of evaluation data items can be obtained, using the test data items. Here, the evaluation data items may be, for example, the forecast line illustrated in FIG. 9. Note that the evaluation data items may be any given data. The evaluation data items may include other information such as a recall, an accuracy rate, a precision, and an AUC.

For example, when many forecast lines are obtained, statistical processing can be performed in accordance with the obtained forecast lines. For example, the learning processing unit 140 may generate forecast information at the learning stage, in accordance with a statistic using the M×N patterns of evaluation data items as a sample. Here, the forecast information is information for forecasting a result of a review, of document data items, conducted by the user in accordance with a score output from a learned model. The forecast information in a narrow sense is the forecast curve described above. Alternatively, the forecast information may be other information.

In this way, the learning processing unit 140 can obtain a smooth and highly accurate forecast curve in accordance with, for example, an average value of M×N forecast lines. For example, A2 in FIG. 9 represents a forecast curve obtained from an average value of a plurality of forecast lines.

Note that even with the normal N-fold cross validation, the larger the value of N is, the larger the number of forecast lines can be. However, the number of test data items decreases accordingly, which could result in a decrease in accuracy of processing performed using the test data items. There are N forecast lines, and the test data items account for 1/N of all the data items. Whereas, the smaller the value N is, the smaller the number of the forecast lines is. As a matter of fact, fewer training data items could lead to a decrease in accuracy of a learned model. The training data items account for (N−1)/N of all the data items. In this regard, when the technique of this embodiment increases the number M of the order patterns of the document data items, the number of evaluation data items increases. Hence, the technique does not have to set the value of N to an extreme value. For example, N can be set to a moderate value (e.g., approximately 3 to 5) in consideration of accuracy of a test and a learned model. For example, when M=20 holds, and even if N=3 holds, 20×3=60 patterns of data items can be obtained as evaluation data.

Note that, when obtaining the forecast information, the learning processing unit 140 does not have to use all of the M×N patterns of evaluation data items. For example, when N=3 holds as illustrated in FIG. 10, the training data items account for two-thirds of the total data items. Hence, the processing may be executed, factoring in influence of reduction in accuracy of the learned model. For example, the learning processing unit 140 may obtain forecast information in accordance with some of evaluation data items included in the M×N patterns of evaluation data items and having a learned model whose accuracy was evaluated relatively high, in order to correct the reduction in accuracy. As described above, when 60 patterns of evaluation data items are found, the learning processing unit 140 obtains the forecast information in accordance with evaluation data items at accuracy levels having a margin of a plus or minus Y-th accuracy level (2Y+1 patterns from an X−Y-th accuracy level to an X+Y-th accuracy level), mainly focusing on an evaluation data item at an X-th accuracy level. In this case, X is a value smaller than a median value (30 or 31), and may be, in a narrow sense, ¼ or more (X≤15). Furthermore, the value Y can be changed in various manners. For example, the value Y may be set so that the lowest accuracy level (the X+Y-th accuracy level) used for processing is greater than, or equal to, the median value.

Moreover, the learning processing unit 140 may calculate variance and standard variation deviation from a plurality of forecast lines. For example, if the standard deviation is set to σ, the learning processing unit 140 may obtain 1.96 σ above or below a forecast curve, obtained as the average value, as a confidence interval at the 95% level. In the example of FIG. 9, A3 represents a curve 1.96 σ above, and A4 represents a curve 1.96 σ below. An interval between A3 and A4 represents a confidence interval at the 95% level. For example, the learning processing unit 140 performs processing of storing, in the storage unit 200, the information represented by A2 to A3 in the graph of FIG. 9.

Furthermore, the learning processing unit 140 may determine, as an outlier, a data item outside a range of 3 σ above or below, and remove the outlier from the processing. Removal of the outlier can improve accuracy in the processing.

The inference processing unit 160 may perform processing of outputting forecast information as information indicating a result of forecasting inference processing. For example, the inference processing unit 160 reads the graph shown in FIG. 9 from the storage unit 200, and causes the display control unit 170 to display the graph. In this way, the user of the terminal device 20 can view a forecast curve and a confidence interval. Hence, in the case where no document data relevant to a given event is found, the user can determine whether the case is a reasonable result.

Furthermore, if no document data item relevant to a given event is found even though a high score range is viewed, the display control unit 170 may perform processing of presenting information based on statistical processing. For example, the inference processing unit 160 may perform processing of obtaining a margin of error (MoE) in accordance with an equation (5) below. In the equation (5) below, p represents an assumed concentration; that is, a rate of forecasting document data items included in target document data items and relevant to a given event. For example, the learning processing unit 140 may estimate p at the stage of learning processing. The number of viewed documents indicates the number of document data items reviewed by the user. The number of viewed documents may be obtained from, for example, history of a review operation (e.g., an operation of selecting a document data item from a list) performed by the user on the terminal device 20.

$$\begin{matrix}[ Math . 5 ] & \\ MoE = 2 \times 1.96 \times \sqrt{\frac{p ( 1 - p )}{\begin{matrix}Number of Viewed \\ Documents\end{matrix}}} & ( 5 )\end{matrix}$$

For example, as a criterion of a limit of detection or below (i.e., the fact that no document data item relevant to a given event is found even though a high score range is viewed), the display control unit 170 may perform processing of presenting information indicating “not found at a concentration having an error of Z % at a confidence level of 95%” in accordance with the above equation (5). Here, Z represents the MoE in the above equation (5). For example, in a case where the assumed concentration is 0.01%, and where the user cannot find any document data items relevant to a given event even though he or she has reviewed 1000 document data items, the MoE obtained by the above equation (5) is 0.1. In this case, the display control unit 170 displays a message “Limit of Detection or Below=Not Found at a Concentration Having an Error of 0.1% at a Confidence Rate of 95%”. In this way, when no document data item relevant to a given event is found, this fact can be presented to the user with objective data in accordance with statistical processing.

Note that the technique of this embodiment shall not be limited to the one applied to the information processing device 10. The technique may be applied to a method, for processing information, executing the steps below. The method, for processing information, causes the information processing device 10 to carry out steps of: causing the information processing device 10 to perform: obtaining document data; performing morphological analysis on the document data; determining a feature in accordance with a result of the morphological analysis; and performing machine learning to determine a weight of a morpheme in a model in accordance with the feature. The morpheme is obtained by the morphological analysis, and the model is either a linear model or a generalized linear model. The machine learning involves performing processing of deleting, from input data of the model. The feature corresponds to the morpheme having the weight a value of which is determined to be smaller than, or equal to, a given threshold value.

Furthermore, this embodiment has been discussed so far in detail. A person skilled in the art will readily appreciate that many modifications are possible without substantially departing from the new matter and advantageous effects of this embodiment. Accordingly, all such modifications are included in the scope of the present disclosure. For example, terms that appear at least once in the Specification or in the drawings along with another broader or synonymous terms can be replaced with the other broader or synonymous terms in any part of the Specification or the drawings. Moreover, all the combinations of this embodiment and the modifications are encompassed in the scope of the present disclosure. Furthermore, the configurations and operations of the information processing device and the terminal device, among others, are not limited to those described in this embodiment, and various modifications are possible.

What is claimed is:

1. An information processing device, comprising:
an obtaining unit configured to obtain document data;
an analysis processing unit configured to perform morphological analysis of the document data;
a feature determining unit configured to determine a feature in accordance with a result of the morphological analysis; and
a learning processing unit configured to perform machine learning to determine a weight of a morpheme in a model in accordance with the feature, the morpheme being obtained by the morphological analysis, and the model being either a linear model or a generalized linear model,
wherein the learning processing unit
performs processing of deleting, from input data of the model, the feature corresponding to the morpheme having the weight a value of which is determined to be smaller than, or equal to, a given threshold value.

2. The information processing device according to claim 1,
wherein the learning processing unit:
is switchable between ON and OFF of ensemble learning of obtaining, as the model, a plurality of models to be used in combination in inference processing; and
performs processing of evaluating the model, and, if performance of the model is determined to be lower than, or equal to, a predetermined level, turns OFF the ensemble learning, and continues the machine learning.

3. The information processing device according to claim 1,
wherein the learning processing unit
performs processing of evaluating the model, and, if performance of the model is determined to be lower than, or equal to, a predetermined level in the processing of evaluating, continues the machine learning while the feature determining unit changes a feature model to be used for determining the feature.

4. The information processing device according to claim 1,
wherein the feature determining unit
determines a metadata feature in accordance with metadata assigned to the document data, the metadata feature being a feature corresponding to the metadata, and
the learning processing unit
performs the machine learning in accordance with the feature corresponding to the morpheme and the metadata feature.

5. The information processing device according to claim 4,
wherein, in a case where first to P-th (P is an integer of 1 or more) pre-corrected features are obtained as pre-corrected features corresponding to the metadata, and where first to Q-th (Q is an integer of 1 or more) documents are obtained as the document data,
the feature determining unit corrects the first to the P-th pre-corrected features in accordance with the P of the pre-corrected features, the Q of the documents, a first norm obtained with an i-th pre-corrected feature (i is an integer of 1 or more and P or less) that appears in the first to the Q-th documents, and a second norm obtained with the first to P-th pre-corrected features that appear in a j-th (j is an integer of 1 or more and Q or less) document, in order to determine the metadata feature.

6. The information processing device according to claim 1, further comprising
an inference processing unit configured to perform processing of inference target data that is the document data to be inferred, in accordance with a leaned model that is the model on which the learning processing unit has performed the machine learning,
wherein the inference processing unit
performs processing of outputting, as a score, probability data indicating probability that the inference target data is related to a given event.

7. The information processing device according to claim 1, further comprising
an inference processing unit configured to perform processing of inference target data that is the document data to be inferred, in accordance with a leaned model that is the model on which the learning processing unit has performed the machine learning,
wherein the inference processing unit performs processing of:
dividing the inference target data into a plurality of blocks in any given length; and outputting probability data for each of the plurality of blocks, the probability data being provided as a score and indicating a probability relevant to a given event.

8. The information processing device according to claim 7,
wherein the inference processing unit
compares, for each of the plurality of blocks, the score and a threshold value independent of a genre of the inference target data, and determines a display mode of each block in accordance with a result of the comparison.

9. The information processing device according to claim 7,
wherein if a plurality of inference target data items are obtained as the document data to be inferred, the inference processing unit performs processing of:
calculating the score for each of the plurality of inference target data items; and
outputting the score for each of the plurality of blocks for inference target data items included in the plurality of inference target data items and having relatively high scores.

10. The information processing device according to claim 1,
wherein if a plurality of learning document data items are obtained as the document data, the learning processing unit:
sorts the plurality of learning document data items to generate first to M-th (M is an integer of 2 or more) learning data items different from one another; and
performs N-fold normal cross validation on each of the first to the M-th learning data items to obtain M×N patterns of evaluation data items.

11. The information processing device according to claim 10, further comprising
an inference processing unit configured to perform inference processing of inference target data that is the document data to be inferred, in accordance with a leaned model that is the model on which the learning processing unit has performed the machine learning,
wherein the learning processing unit
generates forecast information, in accordance with a statistic using the M×N patterns of evaluation data items as a sample, and
the inference processing unit
outputs the forecast information as information indicating a result of forecasting the inference processing.

12. A method, for processing information, causing an information processing device to carry out steps of:
obtaining document data;
performing morphological analysis on the document data;
determining a feature in accordance with a result of the morphological analysis; and
performing machine learning to determine a weight of a morpheme in a model in accordance with the feature, the morpheme being obtained by the morphological analysis, and the model being either a linear model or a generalized linear model,
wherein the machine learning involves
performing processing of deleting, from input data of the model, the feature corresponding to the morpheme having the weight a value of which is determined to be smaller than, or equal to, a given threshold value.
